(19) United States
(12) Patent Application Publication
(10) Pub. No.: US 2024/0083056 A1
(43) Pub. Date: Mar. 14, 2024

(54) SHAVER HANDLE AND METHOD OF MANUFACTURING

(71) Applicant: BIC Violex Single Member S.A., Anoixi (GR)

(72) Inventors: Spiros GRATSIAS, Anoixi (GR); Efstratios CHRISTOFIDELLIS, Anoixi (GR); Ioannis - Marios PSIMADAS, Anoixi (GR); Ioannis BOZIKIS, Anoixi (GR); Phaedon PAPAGEORGIS, Anoixi (GR)

(73) Assignee: BIC Violex Single Member S.A., Anoixi (GR)

(21) Appl. No.: 18/515,931

(22) Filed: Nov. 21, 2023

Related U.S. Application Data
(63) Continuation of application No. 18/175,428, filed on Feb. 27, 2023.
Application No. 18/175,428 is a continuation of application No. 16/492,357, filed on Sep. 9, 2019, now abandoned.

(30) Foreign Application Priority Data
Mar. 10, 2017 (EP) 17160416.8
Mar. 10, 2017 (EP) 17160417.6

(51) Int. Cl. B26B 21/52; B29C 64/393; B33Y 50/02; B33Y 80/00; G05B 19/4099

(52) U.S. Cl. CPC B26B 21/528; B29C 64/393; B33Y 50/02; B33Y 80/00; G05B 19/4099; B26B 21/521; B26B 21/522; B29L 2031/769

(57) ABSTRACT

A handle for a wet shaver, having a handle body adapted to be held by a user and a head supporting portion adapted to support a shaver head. The handle body had a cell structure formed by juxtaposed hollow cells separated by solid walls.

### CROSS REFERENCE TO RELATED APPLICATIONS

This application is a continuation of prior U.S. application Ser. No. 18/175,428, filed on Feb. 27, 2023, which is a continuation of U.S. application Ser. No. 16/492,357, filed on Sep. 9, 2019, which claims priority to National Stage Application of International Application No. PCT/EP2018/055929, filed on Mar. 9, 2018, now published as WO2018/162720 and which claims priority to European Application No. 17160416.8, filed Mar. 10, 2017, and European Application No. 17160417.6, filed Mar. 10, 2017, the entirety of which is incorporated herein by reference.

### FIELD

The disclosure relates to shaver handles, shavers including such handles and methods of manufacturing the same.

### BACKGROUND

Shaver handles are usually compact plastic molded parts, molded as a single part or sometimes molded as several parts which are later assembled.

WO2006081842 shows an example of a known shaver handle.

One of the purposes of the present disclosure is to improve the shaver handles of the prior art, in particular with regard to material consumption and economy.

### SUMMARY

Thus, the present disclosure proposes a handle for a wet shaver, having:
a handle body adapted to be held by a user; and
a head supporting portion adapted to support a shaver head having at least one blade,
   the handle body having a cell structure formed by juxtaposed hollow cells at least partly separated by solid walls, said juxtaposed hollow cells being oriented in more than one direction.

Thanks to these features, the mechanical structure of the handle body can be highly efficient and may save a lot of material compared to compact handles full of solid material, for the same or similar mechanical properties.

Embodiments of such a shaver handle may incorporate one or more of the following features:
said cell structure haS an envelope volume Vt which encompasses a certain empty volume Ve, a ratio Ve/Vt of said empty volume on said envelope volume being between 33% and 90%;
said ratio Ve/Vt is more than 65%;
said juxtaposed hollow cells has more than one shape and form;
said cell structure is formed by using a space partitioning method;
said cell structure is formed as a Voronoi diagram;
said cell structure is formed as a honeycomb cell structure;
the handle has a bending efficiency ratio Rbe of more than 1.20 10⁻⁴ N·mm⁻⁴, wherein said bending efficiency ratio is defined as:

Rbe=(F/d)/Vm, wherein:
F is a force applied to a distal end of the handle body while the head supporting portion of the handle is fixed, said force being applied substantially perpendicularly to a general direction of the handle,
d is a resulting displacement of the distal end of the handle,
Vm is the volume of solid material of the handle,
   wherein the ratio Rbe is higher compared to a compact handle of the same external shape;
said bending efficiency ratio is more than 1.30 10⁻⁴ N·mm⁻⁴;
said handle body has an outside surface defining a shape of said handle body and said cell structure includes a grid shell structure forming a skin which continuously extends according to said outside surface and surrounds an inner volume, the grid shell structure forming said hollow cells which are open toward the inner volume and at the outside surface, and said solid walls separating said hollow cells parallel to said outside surface;
said inner volume is empty and thus deprived of solid walls;
said cell structure is formed along the whole volume of the handle;
the handle body extends longitudinally along a central line between a distal end and a proximal end close to the head supporting portion, and said grid shell structure continuously extends around said central line;
said grid shell structure has a top portion, a bottom portion and two side portions all extending along the central line from the distal end to the proximal end, and said grid shell structure forms an apex at said distal end, continuously joining the top portion, bottom portion and side portions;
said hollow cells represent between 30% and 60% of said outside surface;
said hollow cells have an average surface density comprised between 0.3 and 3 cells/cm²;
said hollow cells are disposed such that a plane perpendicular to said central line, intersects an average number of empty cells comprised between 3 and 15;
said hollow cells are disposed such that a plane including said distal end and said proximal end, intersects an average number of hollow cells comprised between 3 and 20.

A further object of the disclosure is a shaver comprising a handle with any of the above described features and a shaver head mounted on the head supporting portion of said handle.

Still another object of the disclosure is a method for reducing the amount of raw material used in manufacturing a handle for wet shaver comprising defining a cell containing structure by using a space partionioning algorithm, wherein the material volume used to manufacture said handle is at least 33% inferior compared to a handle having a similar bending efficiency ratio. Said space partinioning algorithm may define a cell containing structure formed as a Voronoi diagram

The above and other objects and advantages will become apparent from the detailed description of one embodiment of the disclosure, considered in conjunction with the accompanying drawings.

### BRIEF DESCRIPTION OF THE DRAWINGS

In the drawings:

FIGS. 1 and 2 are overall perspective views of a shaver according to one embodiment of the disclosure, viewed in two directions,

FIG. 3 is a section view of the shaver of FIGS. 1 and 2, the shaver being cut in the sagittal plane P0 of FIG. 1,

FIGS. 4 and 5 are section views of the handle of the shaver of FIGS. 1-3, respectively cut in planes P1 and P2 of FIG. 3,

FIG. 6 illustrates the envelope surface of the handle of the shaver shown in FIGS. 1-5,

FIG. 7 is a view similar to FIG. 1, for a second embodiment,

FIG. 8 is a section view of the handle body of the shaver of FIG. 7, the section being taken along plane P0 of FIG. 7,

FIG. 9 is a section view in a plane perpendicular to plane P0, in a variant of the second embodiment,

FIG. 10 is a view similar to FIG. 1, for a third embodiment,

FIG. 11 is a perspective view of the handle body of the shaver of FIG. 10, viewed in a direction opposite to that of FIG. 10,

FIG. 12 is a section view of the handle body of the shaver of FIG. 10, the section being taken along plane P0 of FIG. 7.

### DETAILED DESCRIPTION

In the drawings, the same reference numbers denote identical or similar elements.

### First Embodiment

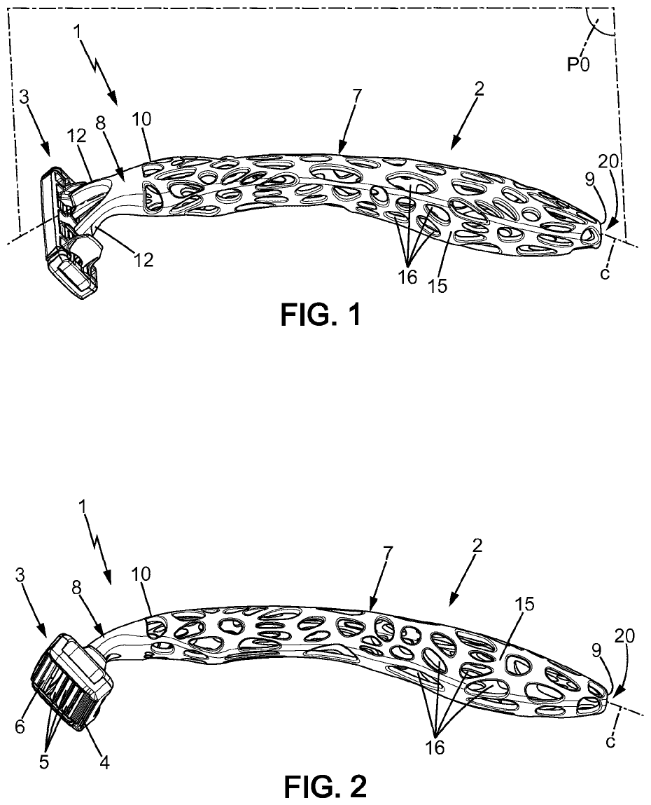

FIGS. 1 and 2 illustrate a shaver 1 according to a first embodiment, comprising a handle 2 and a shaver head 3.

The shaver head 3 may have a guard 4, one or several blades 5 and possibly a cover 6 or similar.

The handle 2 may be formed in one piece. In that case, the handle 2 may be formed by a digital fabrication technology such as three dimensional (3D) printing, also called additive manufacturing. Said 3D printing may be chosen in particular among additive manufacturing methods such as material extrusion (e.g. fused deposition modelling etc.), material jetting, VAT photopolymerization (e.g. digital light processing and electron beam melting, stereolithography etc.), sheet lamination, direct energy deposition, powder bed fusion (e.g. laser sintering etc.) and binder jetting. Additionally a second step may follow, having the part shaped using conventional techniques (e.g. milling).

Alternatively, the handle may be formed in two or more parts which are later assembled together. In that case, the handle may be manufactured by injection molding or by any known manufacturing method including additive manufacturing.

The handle 2 may be formed in one or several materials. For instance, the handle 2 may be formed in one or several of the following materials: plastic materials, metals, mixtures of synthetic and natural materials including wood and paper, etc.

The handle 2 may comprise an elongated handle body 7 and a head supporting portion 8 supporting the shaver head 3. The shaver head 3 may be removably or non-removably attached to the head supporting portion 8.

The handle body 7 is adapted to be held in hand by a user. The handle body 7 extends between a distal end 9 (opposite the head supporting portion 8) and a proximal end 10 (close to the head portion 8), along a central line C. The central line C may be curved. The central line C may be included in a sagittal plane P0.

The shaver head 3 may be connected to the head supporting portion 8 by any known way, for instance pivotally around a pivot axis perpendicular to the sagittal plane P0, or otherwise.

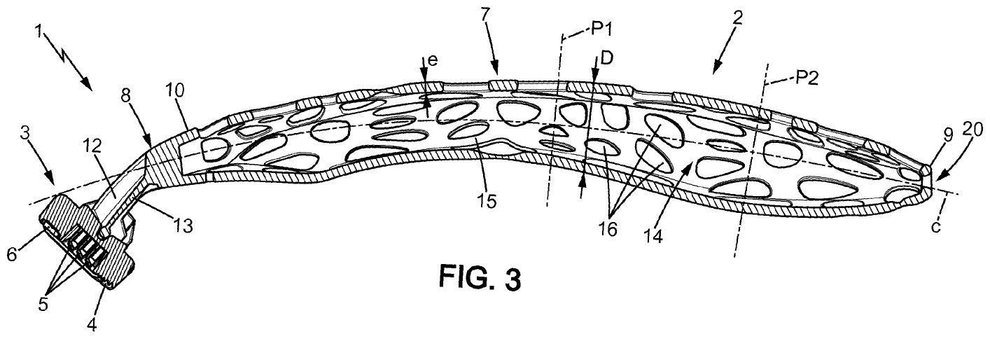

In the example shown in the drawings, as can be seen in particular in FIG. 3, the shaver head 3 may be pivotally mounted on two lateral arms 12 belonging to the head supporting portion 8 and elastically biased to a rest position by an elastic tongue 13 also belonging to the head supporting portion 8. Any other known way of mounting the shaver head 3 to the head supporting portion 8 would be possible.

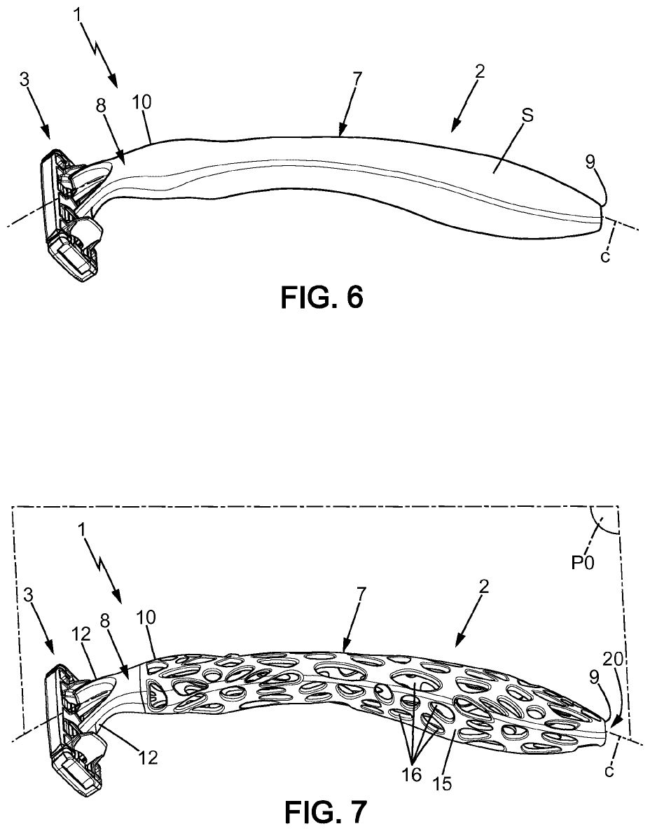

As shown in FIGS. 1-5, the handle body 7 may have a cell structure formed by juxtaposed hollow cells 16, at least partly separated by solid walls 15. The solid walls 15 may form a continuous, single solid part. The cell structure has an envelope volume Vt, which is the internal volume comprised by an envelope surface S of the handle 2 as shown in FIG. 6.

The hollow cells 16 may have more than one shape and form, for instance 1 or 2 or 3 or 4 or 5 or 6 or 7 or 8 or 9 or 10 or 11 or 12 or 13 or 14 or 15 or 16 or 17 or 18 or 19 or 20 or more different shapes and forms.

The hollow cells 16 may have may have only curved (not angled) extremities/edges. The hollow cells 16 may have ovoidal extremities.

The envelope volume Vt encompasses a certain empty volume Ve.

The ratio Ve/Vt of said empty volume on said envelope volume being between 33% and 90%, preferably more than 65%.

The solid walls 15 may form a network of solid threads or arms which are connected together.

The cell structure 15, 16 may be formed as any structure. The cell structure 15, 16 may be formed by using a space partitioning algorithm. Space partitioning is the process of dividing a space into non-overlapping regions, using mathematical diagrams or algorithms. Voronoi diagrams are among the most popular ways of dividing a space into partitions. The cell structure may be formed as for example a Voronoi diagram.

In a particularly advantageous embodiment, as shown in FIGS. 1-5, said cell structure 15, 16 is a grid shell structure. Such grid shell structure forms a continuous skin or shell which extends substantially on the envelope surface S of the handle body, thus defining the external shape of the handle body 7 and surrounding an inner volume 14 of the handle body. In that case, the above mentioned hollow cells 16 are formed in the grid shell structure and are open towards the inner volume 14 and at the envelope surface S, and said solid walls 15 are separating said hollow cells 16 parallel the envelope surface S of the handle body.

In the example shown in the drawings, the inner volume 14 is empty and free of solid walls. In other embodiments, not shown, the inner volume 14 may include solid walls belonging to the cell structure and defining empty cells, for instance according to a 3D Voronoi diagram, in which case said cell structure 15, 16 may be formed along the whole volume of the handle. In other embodiments, the handle body may be produced around any object (e.g. an insert made of any known material) entrapping it and/or enabling it to move freely in the handle body 7.

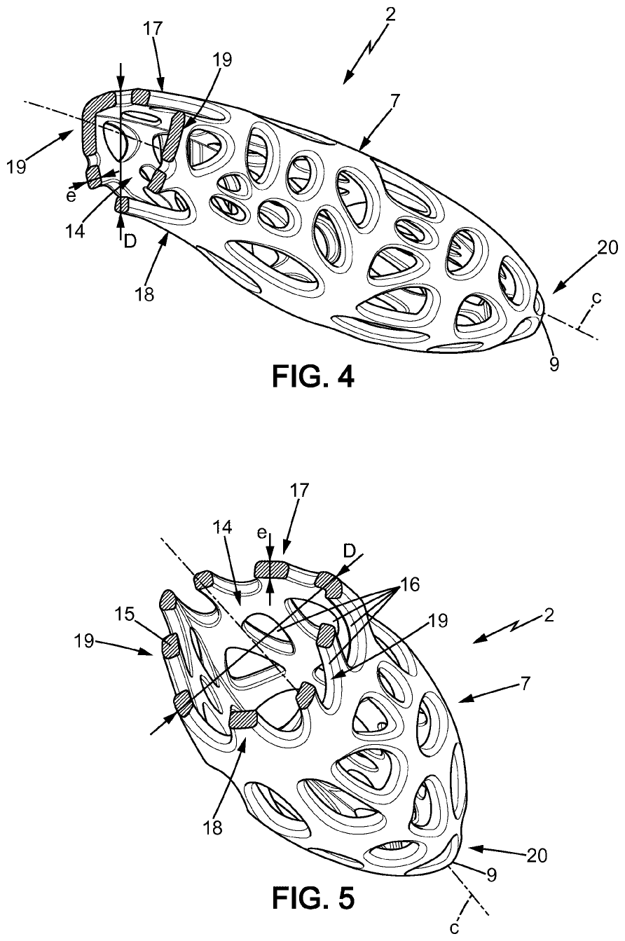

The grid shell structure 15, 16 may extend continuously around the central line C. The grid shell structure 15, 16 may define a top portion 17, a bottom portion 18 and two side portions 19 all extending along the central line from the distal end to the proximal end, and said grid shell structure forms an apex 20 at the distal end 9 of the handle body (FIGS. 4-5), continuously joining the top portion 17, bottom portion 18 and side portions 19.

The grid shell structure 15, 16 may be such that said empty cells 16 represent between 30% and 60% of said outside surface.

The grid shell structure 15, 16 may be such that said empty cells 16 have an average surface density (parallel to the envelope surface S) comprised between 0.3 and 3 cells/cm².

The grid shell structure 15, 16 may be such that a plane perpendicular to said central line C and intersecting the handle body 7 (for instance the planes P1, P2 shown in FIG. 3) intersects an average number of empty cells 16 comprised between 3 and 15.

The grid shell structure 15, 16 may be such that a plane including said distal end 9 and said proximal end 10 (for instance the sagittal plane P0), intersects an average number of empty cells 16 comprised between 3 and 20.

Typically, the thickness e of the grid shell structure 15, 16 may be a few millimeters, for instance between 0.3 and 5 mm; the transverse dimension D of the grid shell structure 15, 16, perpendicular to the central line C, may be for instance between about 8 and 25 mm.

The length of grid shell structure 15, 16 may be for instance of about 90 to 120 mm and the total length of the shaver handle 2 may be for instance between about 110 to 140 mm. These dimensions may be typical for a normal handle and are not deemed to be limitative. The handle can also be smaller, for instance with a length in the range of about 30-80 mm, in which case the length of the grid shell structure 15, 16 would be consequently reduced. Additionally the handle may have the grid shell structure 15, 16 only in a portion of a length of the handle and not in the whole volume.

Thanks to the above features, the shaver handle 2 according to the disclosure saves a lot of material compared to existing shaver handles, thus also saving weight and energy. Some comparative examples are shown in Table 1 below.

The method used to calculate the values in Table 1 is as follows:

A variety of commercially available shaver handles were gathered.

The volume of solid material (Vm) was measured by inserting each handle at a time in a volume measuring tube full of deionized water and measuring the water volume coming out of the tube.

After this first measurement, each handle was covered with a plastic film, simulating that the handle has a compact (full of material) shape and similarly the handle was inserted in the volume measuring tube, again full of deionized water. The water volume coming out of the tube was measured, corresponding to the envelope volume (Vt).

Then the empty volume (Ve) was calculated by using the formula: Ve=Vt−Vm.

Finally the ratio Ve/Vt was calculated.

TABLE 1

| | Volume | | |
|---|---|---|---|
| | of solid | Enveloppe | Ratio empty volume/ |
| | material | volume | enveloppe volume |
| Shaver name | Vm [ml] | Vt [ml] | Ve/Vt [%] |
| Gillette Mach3 ® | 8.30 | 11.00 | 24.55 |
| Gillette Body ® | 15.90 | 19.50 | 18.46 |
| Gillette Flexball ® | 16.40 | 19.80 | 17.17 |
| Gillette Guard ® | 11.80 | 17.50 | 32.57 |
| Gillette Venus Swirl ® | 23.80 | 24.10 | 1.24 |
| King of Shaves | 13.40 | 17.20 | 22.09 |
| Azor SD ® | | | |
| BIC 3 ® | 4.30 | 6.30 | 31.75 |
| BIC Comfort 3 | 17.40 | 20.00 | 13.00 |
| Advance ® | | | |
| BIC Flex 5 ® | 12.40 | 18.45 | 32.79 |
| BIC Ying Yang ® | 13.50 | 18.85 | 28.38 |
| Embodiment | 4.50 | 18.20 | 75.27 |
| as shown in | | | |
| the FIGS. 1-5 | | | |

In addition to saving material and minimizing energy footprint of the product, the disclosure also enables to improve the mechanical efficiency of the material used.

This mechanical efficiency, for a shaver handle, can be measured by a bending efficiency ratio Rbe, which is defined as:

Rbe=(F/d)/Vm,

wherein:
F is a force applied to the distal end 9 of the handle body while the head supporting portion 8 of the handle is fixed, said force F being applied substantially perpendicularly to a general direction of the handle (more specifically, this force F may be applied downwards, in the sagittal plane P0 and substantially perpendicular to the central line C at the distal end 9),
d is a resulting displacement of the distal end 9 of the handle (vertical displacement),
Vm is the volume of solid material of the handle.

This bending efficiency ratio Rbe may be possibly obtained from a theoretical analysis, in particular from a finite element analysis which uses a 3d digital model to calculate the bending efficiency ratio by taking as input the force F applied to a distal end 9 of the handle and calculating the displacement d of the distal end 9 of the handle and the volume Vm of solid material of the handle.

The following table 2 shows the comparison of the calculation of the bending efficiency ratio Rbe in the case of the shaver handle of FIGS. 1-5 compared to a compact shaver handle having the same envelope surface as shown in FIG. 6:

TABLE 2

| | Volume | | | |
|---|---|---|---|---|
| | of solid | | | |
| | material | F | d | Rbe |
| | Vm [ml] | [N] | [mm] | [N · mm⁻⁴] |
| Handle of | 58.73 | 2.08 | 2.57 | 1.38 10⁻⁴ |
| FIGS. 1-5 | | | | |
| Corresponding | 19.537 | 5 | 2.61 | 0.98 10⁻⁴ |
| compact handle | | | | |

Table 2 shows that the mechanical efficiency, measured by the ratio Rbe, is higher in the case of the present disclosure compared to a compact handle of the same external shape.

More generally, the bending efficiency ratio of a handle according to the present disclosure is preferably more than 1.20 10⁻⁴ N·mm⁻⁴, even more preferably larger than 1.30 10⁻⁴ N·mm⁻⁴.

In addition to the above advantages, the present diclosure also provides better gripping for the user, increasing the comfort and the feeling of safety while shaving.

In the second and third embodiments, described below, the general structure of the handle body and the above advantages are kept, so that these second and third embodiments will not be described again in detail. Mainly the differences over the first embodiment will be explained below.

### Second Embodiment

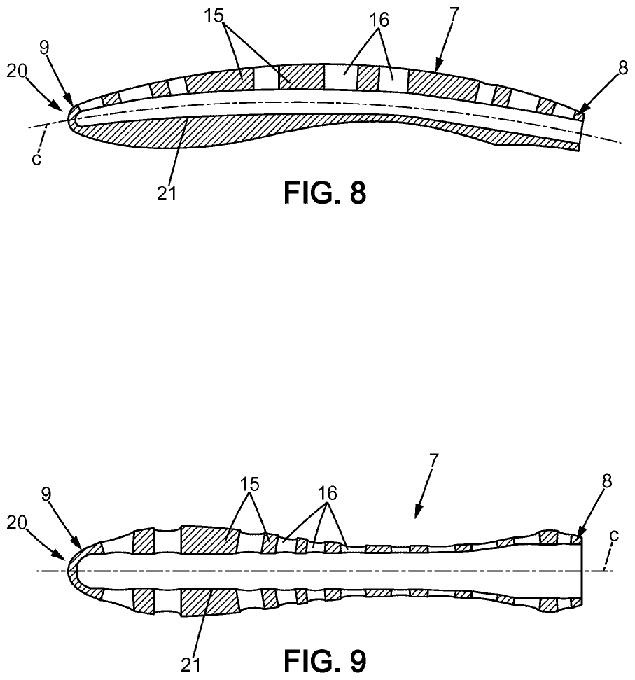

In the second embodiment, shown in FIGS. 7-8, the handle body 7 may be for instance injection molded and the head supporting portion 8 may be formed as a separate part and fixed to the proximal end 10 of the handle body, for instance by fitting and/or ultrasound welding or by any other way.

The handle body 7 may include a central empty channel 21, obtained by using a slider in the mold if the handle body is manufactured by injection molding. The central channel 21 may be axially open at the proximal end 10 of the central body. The central channel 21 may extend along the central line C of the handle, which is curved in the example of FIGS. 7-8. The central channel 21 and the central line C of the handle may also be straight, as illustrated in the variant of FIG. 9.

In the second embodiment, the grid shell structure 15, 16 may have a larger and/or variable thickness compared to the first embodiment, the maximum width of channel 21 being defined by the neck of the handle body 7.

### Third Embodiment

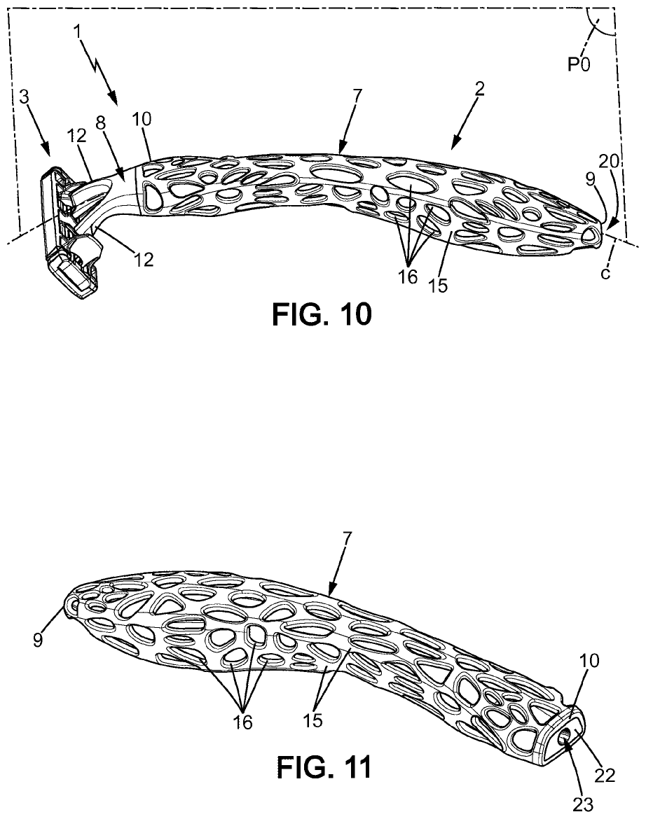

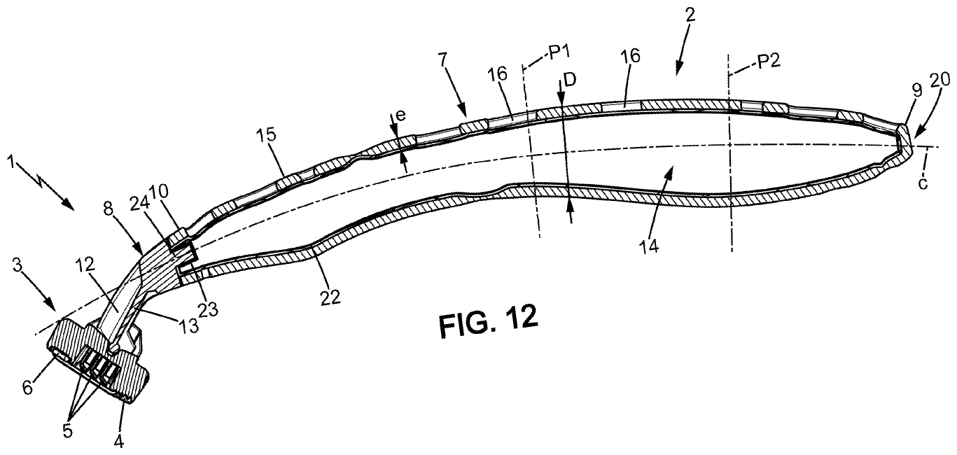

In the third embodiment, shown in FIGS. 10-12, the handle body 7 may be for instance injection molded on an insert 22 and the head supporting portion 8 may be formed as a separate part and fixed to the handle body 7 and/to the insert 22 at the proximal end 10 of the handle body, for instance by fitting and/or ultrasound welding or by any other way. For instance, the insert 22 may have a hole 23 at the proximal end 10 of the handle body and the head supporting portion 8 may have a lug 24 fitted into said hole 23.

The insert 22 may advantageoulsy be hollow, defining the empty inner volume 14. For instance, the insert 22 may be blow molded. The thickness of the insert 22 may typically range from a few tens of millimeters to a few millimeters.

In one specific example, the material of the insert may be PCTG (Glycol-modified Poly-Cyclohexylenedimethylene Terephthalate), for instance a PCTG with high optical transparency.

In a particular example, the grid shell structure 15, 16 may be injection molded from thermoplastic elastomer (TPE) on the insert 22.

1-15. (canceled)

16. A handle for a wet shaver, the handle comprising:
a head supporting portion configured to support a shaver head having at least one blade; and
a handle body that includes a cell structure formed by juxtaposed hollow cells, the juxtaposed hollow cells being at least partly separated by solid walls and arranged about a substantial portion of the handle body in a varying pattern,
wherein the handle has a bending efficiency ratio Rbe of more than 1.20 10⁻⁴ N·mm⁻⁴, the bending efficiency ratio being defined as:
Rbe=(F/d)/Vm, wherein:
F is a force applied to a distal end of the handle body while the head supporting portion of the handle is fixed,
d is a resulting displacement of the distal end, and
Vm is a volume of solid material of the handle, and
wherein the handle has an empty volume ratio of greater than 65%, the empty volume ratio being defined as:
Ve/Vt, wherein:
Vt is an internal volume of the handle comprised by an envelope surface substantially corresponding to an external shape of the handle body, and
Ve=Vm−Vt.

17. The handle of claim 16, wherein the juxtaposed hollow cells have more than one shape and form.

18. The handle of claim 16, wherein the cell structure is formed as a Voronoi diagram.

19. The handle of claim 16, wherein the juxtaposed hollow cells are formed entirely about a volume of the handle.

20. The handle of claim 16, wherein the juxtaposed hollow cells are orientated in more than one direction.

21. The handle of claim 16, wherein each juxtaposed hollow cell of at least a portion of the juxtaposed hollow cells is defined only by curved edges.

22. The handle of claim 16, wherein the juxtaposed hollow cells have an average surface density parallel to the envelope surface in a range of about 0.3 cells/cm² to about 3 cells/cm².

23. The handle of claim 16, wherein the cell structure includes a grid shell structure forming a skin that defines the external shape of the handle body and surrounds an inner volume, the grid shell structure being formed by the juxtaposed hollow cells and the solid walls.

24. The handle of claim 23, wherein the inner volume is empty.

25. The handle of claim 23, wherein the grid shell structure includes a top portion, a bottom portion, and side portions that extend along a central line from the distal end to a proximal end of the handled body, and wherein the grid shell structure forms an apex at the distal end, the apex continuously joining the top, bottom, and side portions.

26. The handle of claim 23, wherein the juxtaposed hollow cells are arranged according to the grid shell structure such that a plane including the distal end and a proximal end of the handle body intersects an average number of about 3 to about 20 of the juxtaposed hollow cells.

27. The handle of claim 23, wherein the handle body extends longitudinally along a central line between the distal end and a proximal end of the handle body, and wherein the grid shell structure extends continuously about the central line.

28. The handle of claim 23, further including an insert trapped within the inner volume.

29. The handle of claim 28, wherein the insert is freely movable within the inner volume.

30. A handle for a wet shaver, the handle consisting of:
a head supporting portion configured to support a shaver head having at least one blade, the head supporting portion including two lateral arms and an elastic tongue that elastically biases the two lateral arms; and
a handle body that includes a cell structure formed by juxtaposed hollow cells, the juxtaposed hollow cells being at least partly separated by solid walls and arranged about a substantial portion of the handle body in a varying pattern, wherein:
the juxtaposed hollow cells have more 20 different shapes and forms,
the cell structure is formed as a Voronoi diagram;
the juxtaposed hollow cells are orientated in more than one direction;
each juxtaposed hollow cell of at least a portion of the juxtaposed hollow cells is defined only by curved edges
the juxtaposed hollow cells have an average surface density parallel to an envelope surface in a range of about 0.3 cells/cm² to about 3 cells/cm²;
the cell structure includes a grid shell structure forming a skin that defines the external shape of the handle body and surrounds an inner volume, the grid shell structure being formed by the juxtaposed hollow cells and the solid walls;
wherein the handle has a bending efficiency ratio Rbe of more than 1.20 10⁻⁴ N·mm⁻⁴, the bending efficiency ratio being defined as:
Rbe=(F/d)/Vm, wherein:
F is a force applied to a distal end of the handle body while the head supporting portion of the handle is fixed,
d is a resulting displacement of the distal end, and
Vm is a volume of solid material of the handle, and
wherein the handle has an empty volume ratio of greater than 65%, the empty volume ratio being defined as:
Ve/Vt, wherein:
Vt is an internal volume of the handle comprised by an envelope surface substantially corresponding to an external shape of the handle body, and
Ve=Vm−Vt; wherein:
the inner volume is empty;
the grid shell structure includes a top portion, a bottom portion, and side portions that extend along a central line from the distal end to a proximal end of the handled body, and wherein the grid shell structure forms an apex at the distal end, the apex continuously joining the top, bottom, and side portions;
the juxtaposed hollow cells are arranged according to the grid shell structure such that a plane including the distal end and a proximal end of the handle body intersects an average number of about 3 to about 20 of the juxtaposed hollow cells;
the handle body extends longitudinally along a central line between the distal end and a proximal end of the handle body;
the grid shell structure extends continuously about the central line;
a thickness of the grid shell structure is between 0.3 mm and 5 mm;
a length of the handle is between 110 mm and 140 mm
the handle is formed by an additive manufacturing process.
